(19) United States
(12) Patent Application Publication
(10) Pub. No.: US 2026/0183914 A1
(43) Pub. Date: Jul. 2, 2026

(54) ELECTRIC NAIL GUN WITH CHIP DISCHARGING FUNCTION

(71) Applicant: BASSO INDUSTRY CORP., Taichung City (TW)

(72) Inventors: Liang-Chi HUNG, Taichung City (TW); Li-Hsin CHANG, Taichung City (TW)

(21) Appl. No.: 19/399,227

(22) Filed: Nov. 24, 2025

(30) Foreign Application Priority Data
Dec. 26, 2024 (TW) 113214266

(51) Int. Cl. B25C 1/04

(52) U.S. Cl. CPC B25C 1/04

(57) ABSTRACT

An electric nail gun with a chip discharging function includes: a nail gun body (81); a nail magazine (84); a nail firing barrel (10) including a nail passageway (11), a tooth slot (12) and an ejecting muzzle (13), wherein the tooth slot (12) is in communication with the nail passageway (11), and the ejecting muzzle (13) is disposed at one end of the nail firing barrel (10); a power mechanism (20) including a cylinder set (21), wherein the cylinder set (21) includes a cylinder (211), a cylinder base (212) and an air storage chamber (213); and a nail striking assembly (30) disposed between the nail firing barrel (10) and the cylinder set (21) and including a piston (31) and a firing pin (32), wherein the firing pin (32) has a push piece (322) and is movable within the tooth slot (12).

### BACKGROUND OF THE DISCLOSURE

### Technical Field

The present disclosure relates to an electric nail gun, especially to an electric nail gun with a chip discharging function.

### Description of Related Art

In an actual operating process, a related-art electric nail gun has problems as follows. A muzzle of a nail passageway is designed in a closed status, and only a nail may be ejected out from the muzzle. When a nail row having plastic connecting sheets is desired to be fired, chips are generated because the plastic connecting sheets are broken. The chips may be accumulated in an accommodation slot used for accommodating a firing pin lift tooth. When the chips of the plastic connecting sheets are accumulated to a certain amount, the firing pin may be clamped or restrained by the chips of the plastic connecting sheets during a forward moving action of the firing pin, and thus a poor situation of the firing pin not being recovered to an initial position is caused.

Accordingly, the applicant of the present disclosure has devoted himself for improving the mentioned problems.

### SUMMARY OF THE DISCLOSURE

An objective of the present disclosure is to provide an electric nail gun with a chip discharging function, which has advantages of preventing chips from being accumulated in a nail passageway to make a firing pin be easily moved and recovered to an initial position.

In order to achieve the above objective, the present disclosure provides an electric nail gun with a chip discharging function, which includes a nail gun body, a nail magazine, a nail firing barrel, a power mechanism and a nail striking assembly. The nail firing barrel is fastened with the nail gun body to be connected to the nail magazine. The nail firing barrel includes a nail passageway, a tooth slot and an ejecting muzzle. The tooth slot is in communication with the nail passageway and disposed at one side of the nail passageway. The ejecting muzzle is disposed at one end of the nail firing barrel away from the nail gun body. The power mechanism is disposed in the nail gun body. The power mechanism includes a cylinder set. The cylinder set is disposed at another side of the ejecting muzzle of the nail firing barrel. The cylinder set includes a cylinder; a cylinder base disposed between the cylinder and the nail firing barrel and an air storage chamber communicating with the cylinder. The nail striking assembly is disposed between the nail firing barrel and the cylinder set. The nail striking assembly includes a piston and a firing pin connected to the piston. The piston is disposed in the cylinder. The firing pin has a push piece, and the firing pin is movable within the tooth slot. Wherein, chips in the tooth slot are pushed out from the ejecting muzzle via the push piece after the nail striking assembly is driven by the power mechanism.

In comparison with related art, the present disclosure has an advantageous feature as follows. The service life of the electric nail gun is greatly prolonged.

### BRIEF DESCRIPTION OF THE DRAWINGS

FIG. 1 is a perspective view showing the assembly of the electric nail gun with the chip discharging function according to the present disclosure;

FIG. 2 is another perspective view showing the assembly of the electric nail gun with the chip discharging function according to the present disclosure;

FIG. 3 is a perspective view showing the assembly of the nail firing barrel according to the present disclosure;

FIG. 4 is another perspective view showing the assembly of the nail firing barrel according to the present disclosure;

FIG. 5 is a cross-sectional view showing an operating status of the electric nail gun with the chip discharging function according to the present disclosure; and

FIG. 6 is a cross-sectional view showing another operating status of the electric nail gun with the chip discharging function according to the present disclosure.

### DETAILED DESCRIPTION OF THE DISCLOSURE

The technical contents of this disclosure will become apparent with the detailed description of embodiments accompanied with the illustration of related drawings as follows. It is intended that the embodiments and drawings disclosed herein are to be considered illustrative rather than restrictive.

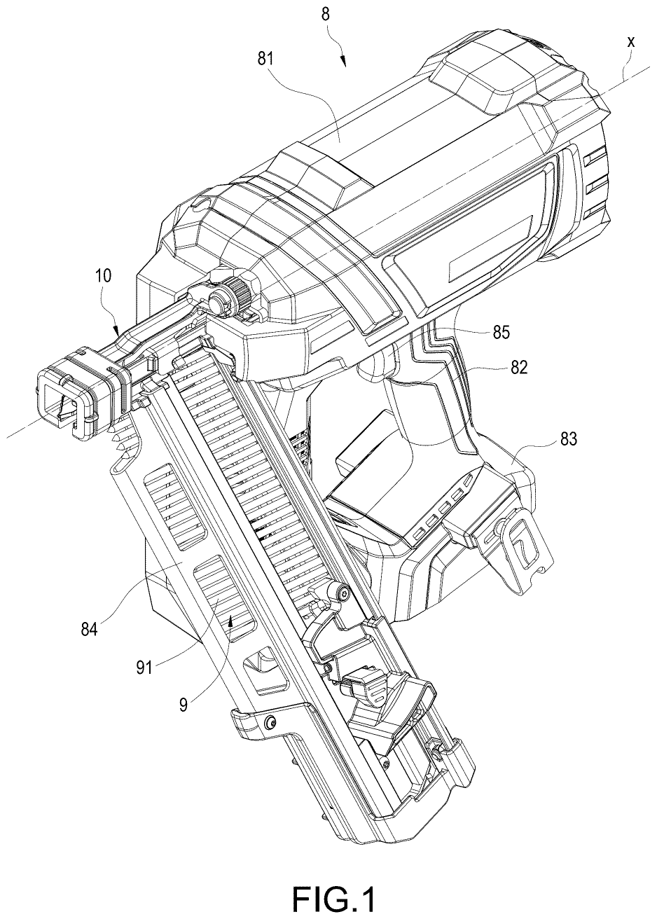

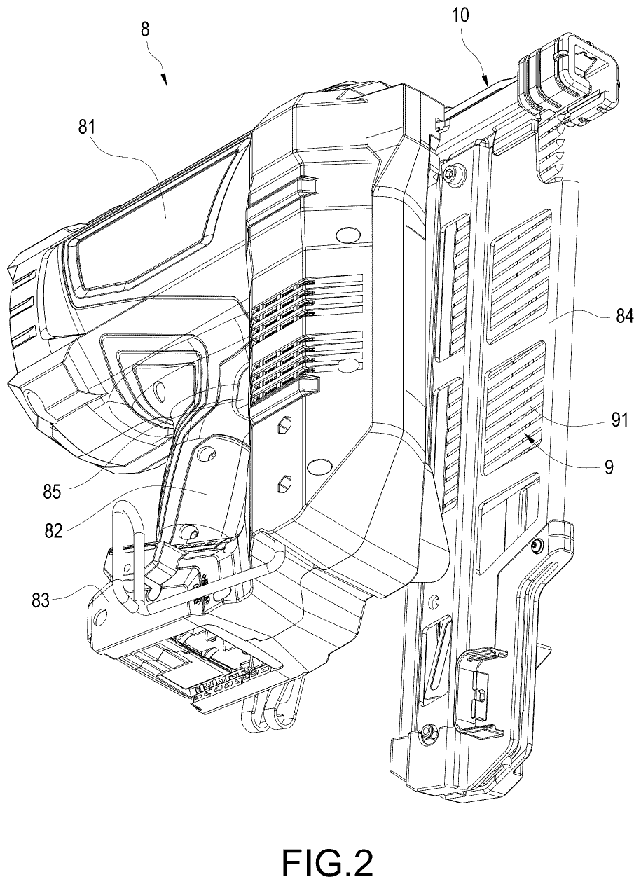

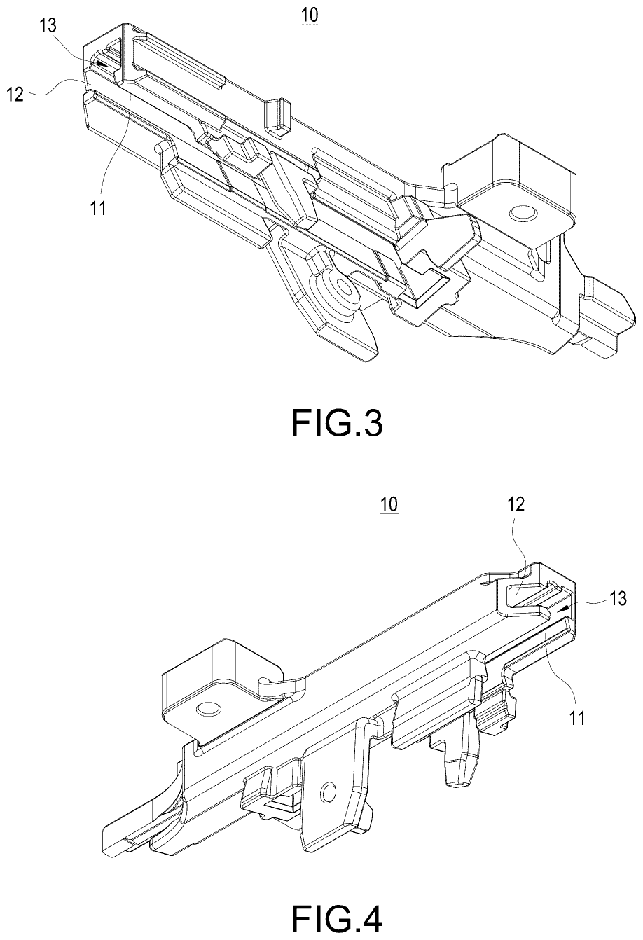

Please refer from FIG. 1 to FIG. 4, the present disclosure provides an electric nail gun with a chip discharging function, which is applicable in an electric nail gun 8 which strikes a nail along an axial direction X. The electric nail gun 8 mainly includes a nail gun body 81, a handgrip 82, a battery part 83, a nail magazine 84, a trigger 85, a nail firing barrel 10, a power mechanism 20 and a nail striking assembly 30. The handgrip 82 is connected to the nail gun body 81 in a direction defined as substantially perpendicular to the axial direction X. The battery part 83 is connected to a rear bottom end of the handgrip 82. The nail gun body 81 is disposed with the nail firing barrel 10 along the striking axial direction X. One end of the nail firing barrel 10 is fastened with the nail gun body 81 to be connected to and in communication with the nail magazine 84. The nail magazine 84 is disposed at a bottom end of the nail gun body 81. The trigger 85 is disposed at a corner end of the handgrip 82 close to the nail gun body 81. A nail row 9 is disposed in the nail magazine 84. The nail row 9 includes a plurality of nails 91 and two plastic connecting sheets (not shown in figures). Each of the nails 91 is mutually stacked with each other, and the two plastic connecting sheets (not shown in figures) are disposed in a middle section of each of the nails 91.

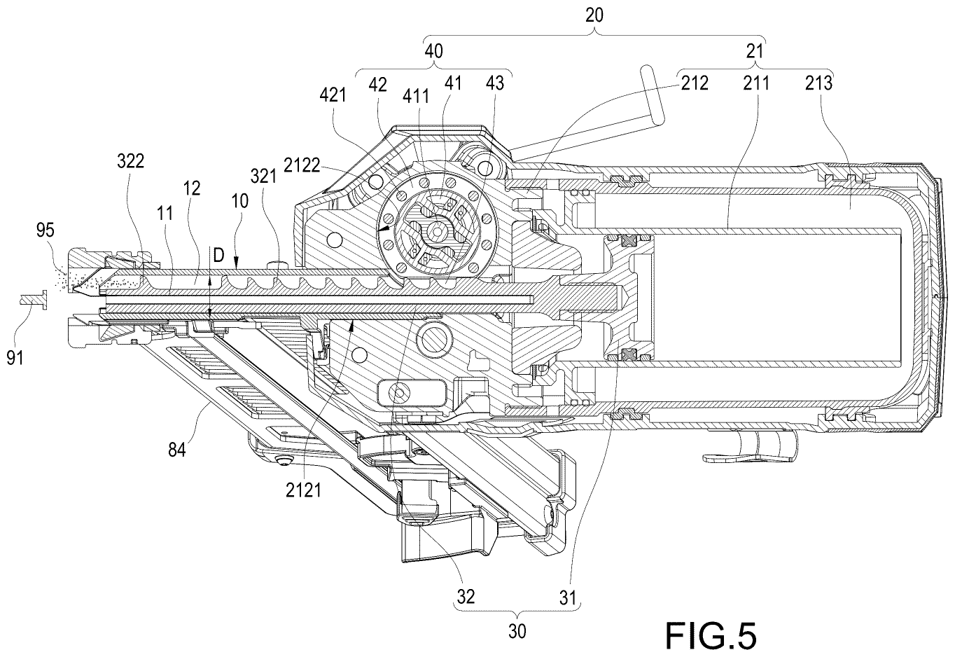

One end of the nail firing barrel 10 is fastened with the nail gun body 81 to be connected to the nail magazine 84. The nail firing barrel 10 includes a nail passageway 11, a tooth slot 12 and an ejecting muzzle 13. The tooth slot 12 is in communication with the nail passageway 11 and disposed at one side of the nail passageway 11. The ejecting muzzle 13 is disposed at one end of the nail firing barrel 10 away from the nail gun body 81. The nail passageway 11 communicates with the nail magazine 84 to make the nails 91 be forwardly conveyed via the nail magazine 84. The tooth slot 12 allows chips 95, generated due to the aforesaid plastic connecting sheets being impacted and broken, to be disposed, as shown in FIG. 5. The tooth slot 12 and the nail passageway 11 are defined with a bore diameter D. The ejecting muzzle 13 has the same bore diameter D defined from the nail passageway 11 along the axial direction X.

The power mechanism 20 is disposed in the nail gun body 81. The power mechanism 20 mainly includes a cylinder set 21. The cylinder set 21 is disposed at a rear side of the nail firing barrel 10.

Please refer to FIG. 5, the power mechanism 20 is disposed in the nail gun body 81. The power mechanism 20 mainly includes the cylinder set 21 and a lift assembly 40. The cylinder set 21 is disposed at another side of the ejecting muzzle 13 of the nail firing barrel 10. The cylinder set 21 mainly includes a cylinder 211, a cylinder base 212 disposed between the cylinder 211 and the nail firing barrel 10 and an air storage chamber 213 communicating with the cylinder 211. The cylinder base 212 includes a first accommodation part 2121 and a second accommodation part 2122. The first accommodation part 2121 is disposed with the nail firing barrel 10. The second accommodation part 2122 is disposed with the lift assembly 40. The lift assembly 40 is disposed between the cylinder 211 and the nail firing barrel 10 and located at one side of the nail striking assembly 30. The lift assembly 40 mainly includes a motor 41, a wheel part 42, and a notch part 43. The motor 41 has a rotation shaft 411. The rotation shaft 411 is connected to the wheel part 42 to drive the wheel part 42 to rotate. The wheel part 42 is disposed with a plurality of columnar members 421 arranged annularly. The notch part 43 is disposed at an edge of the wheel part 42.

The nail striking assembly 30 is disposed between the nail firing barrel 10 and the cylinder 211. The nail striking assembly 30 mainly includes a piston 31 and a firing pin 32. One end of the firing pin 32 is connected to the piston 31 and substantially formed as a cylindrical member. Another end of the firing pin 32 is extended along a direction defined by the nail firing barrel 10. The piston 31 is disposed in the cylinder 211 of the power mechanism 20. The firing pin 32 has a plurality of lift teeth 321 spacedly arranged. Each of the lift teeth 321 is disposed with a push piece 322 arranged at a front side of the firing pin 32. The push piece 322 is disposed at one end of the firing pin 32 away from the piston 31 and close to the ejecting muzzle 13. Each of the lift teeth 321 and the push pieces 322 are all disposed in the tooth slot 12 and simultaneously displaced.

As such, by actuating the motor 41, rotations of the rotation shaft 411 drive the wheel part 42 to make each of the columnar members 421 toggle each of the corresponding lift teeth 321, and thus the firing pin 32 is recovered to an initial position.

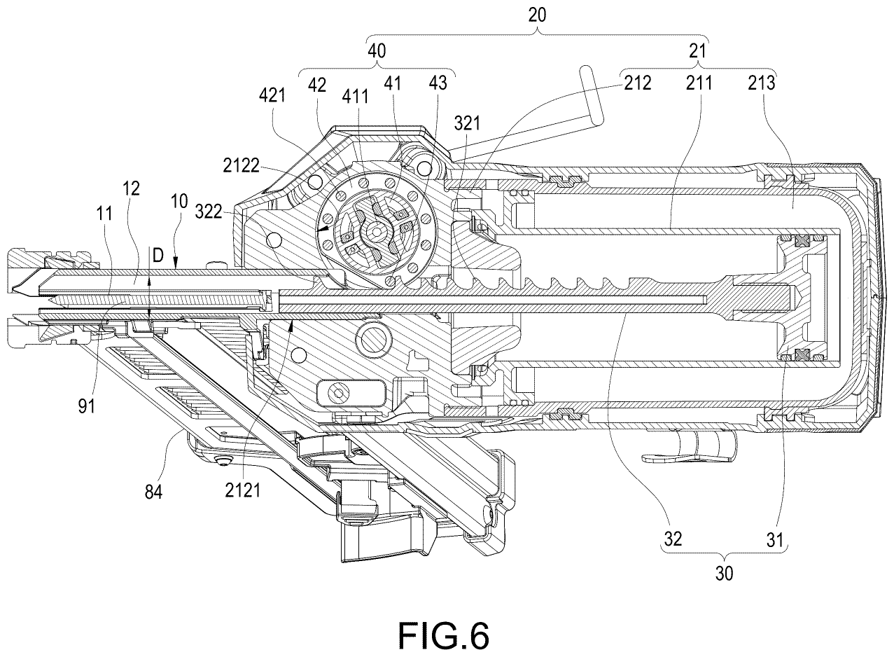

Please refer to FIG. 5 and FIG. 6, a top end of the piston 31 is constantly subjected to high-pressure air because the air storage chamber 213 communicates with the cylinder 211. When being operated, the handgrip 82 is held by a user, the nail firing barrel 10 is disposed at a location close to a surface of a workpiece, the trigger 85 is pulled by the user, the power mechanism 20 drives the motor 41 to make the rotation shaft 411 rotate to the notch part 43 to be aligned with the firing pin 32, and each of the columnar members 421 no longer restrains the lift teeth 321, the high-pressure air stored at the top end the piston 31 pushes the piston 31 and the firing pin 32 to rapidly move towards the nail firing barrel 10, a front distal surface of the firing pin 32 impacts a head part of the nail 91, and the plastic connecting sheets used to hold the nail 91 are broken to make the nail 91 be released from the nail row 9, at this moment the nail 91 continuously move towards the ejecting muzzle 13 to make the nail 91 impale into a workpiece, and the chips 95 generated due to the broken plastic sheets are pushed by push piece 322 to be discharged from the tooth slot 12 towards the ejecting muzzle 13, as shown in FIG. 5. With the motor 41 and the wheel part 42 of the lift assembly 40, the rotations of the rotation shaft 411 drive the wheel part 42 to make each of the columnar members 421 to toggle each of the corresponding lift teeth 321, and thus the firing pin 32 is recovered to the initial position, as shown in FIG. 6.

While this disclosure has been described by means of specific embodiments, numerous modifications and variations may be made thereto by those skilled in the art without departing from the scope and spirit of this disclosure set forth in the claims.

What is claimed is:

1. An electric nail gun with a chip discharging function, comprising:
a nail gun body (81);
a nail magazine (84);
a nail firing barrel (10) fastened with the nail gun body (81) to be connected to the nail magazine (84), and comprising a nail passageway (11), a tooth slot (12) and an ejecting muzzle (13), wherein the tooth slot (12) is in communication with the nail passageway (11) and disposed at one side of the nail passageway (11), and the ejecting muzzle (13) is disposed at one end of the nail firing barrel (10) away from the nail gun body (81);
a power mechanism (20), disposed in the nail gun body (81) and comprising a cylinder set (21), wherein the cylinder set (21) is disposed at another side of the ejecting muzzle (13) of the nail firing barrel (10), and the cylinder set (21) comprises a cylinder (211), a cylinder base (212) disposed between the cylinder (211) and the nail firing barrel (10) and an air storage chamber (213) communicating with the cylinder (211); and
a nail striking assembly (30), disposed between the nail firing barrel (10) and the cylinder set (21), and comprising a piston (31) and a firing pin (32) connected to the piston (31), wherein the piston (31) is disposed in the cylinder (211), the firing pin (32) comprises a push piece (322), and the firing pin (32) is movable within the tooth slot (12);
wherein, chips in the tooth slot (12) are pushed out from the ejecting muzzle (13) via the push piece (322) after the nail striking assembly (30) is driven by the power mechanism (20).

2. The electric nail gun with the chip discharging function according to claim 1, wherein the firing pin (32) further comprises a plurality of lift teeth (321), and the push piece (322) is disposed at a front side of each of the lift teeth (321).

3. The electric nail gun with the chip discharging function according to claim 1, wherein the power mechanism (20) further comprises a lift assembly (40), the lift assembly (40) is disposed in the nail gun body (81) and located at one side of the nail striking assembly (30), the lift assembly (40) comprises a motor (41) and a wheel part (42), the firing pin (32) comprises a plurality of lift teeth (321), the motor (41) comprises a rotation shaft (411), the rotation shaft (411) is connected to the wheel part (42), the wheel part (42) comprises a plurality of columnar members (421), rotations of the rotation shaft (411) drive the wheel part (42) to make each of the columnar members (421) toggle each of the corresponding lift teeth (321), and thus the firing pin (32) is recovered to an initial position.

4. The electric nail gun with the chip discharging function according to claim 3, wherein one end of the firing pin (32) is connected to the piston (31), and the firing pin (32) is formed as a cylindrical member.

5. The electric nail gun with the chip discharging function according to claim 4, wherein the tooth slot (12) and the nail passageway (11) are defined with a bore diameter (D), and the ejecting muzzle (13) is defined with the same bore diameter (D) from the nail passageway (11) along an axial direction (X).
